(19) United States
(12) Patent Application Publication
(10) Pub. No.: US 2022/0067660 A1
(43) Pub. Date: Mar. 3, 2022

(54) SYSTEMS AND METHODS FOR INTERMEDIATING SERVICES OR PROJECTS RELATED TO HOME IMPROVEMENT

(71) Applicant: Home Wikii Inc., Gardena, CA (US)

(72) Inventors: Ki-Jung NAM, Gardena, CA (US); Young-Woo NAM, Seoul (KR)

(73) Assignee: Home Wikii Inc., Gardena, CA (US)

(21) Appl. No.: 17/009,944

(22) Filed: Sep. 2, 2020

(51) Int. Cl. G06Q 10/10; G06Q 50/08; G06Q 10/00; G06Q 50/16; G06Q 30/08; G06Q 30/06; G06Q 50/18; G06Q 20/08; G06Q 10/06; G06Q 30/02; G06Q 50/00

(52) U.S. Cl. CPC G06Q 10/103; G06Q 50/08; G06Q 10/20; G06Q 50/16; G06Q 30/08; G06F 3/0482; G06Q 50/18; G06Q 20/085; G06Q 10/06395; G06Q 30/0205; G06Q 50/01; G06Q 30/0611

(57) ABSTRACT

A system and method for supporting a series of processes of searching and selection professionals, contract, project progress, inspection, and payment process are disclosed. In the system and method, homeowners and professionals can contact more counterparties, homeowners can find more suitable professionals and order projects at a reasonable price, and professionals acquire more projects without unnecessary cost and effort. It can reduce the possibility of disputes between homeowners and professionals, and provide evidence that can clearly determine the cause of a dispute.

### TECHNICAL FIELD

The present invention is about ordering a project such as a new construction and addition, remodeling, installation, replacement, and repair of a house or building by an owner of a house or building (hereinafter, “owner”). It relates to a system and method that associates owners with construction experts (hereinafter referred to as “professionals”) to make it easier to find their counterparties and supports the steps from project price estimation to payment process.

### BACKGROUND

When building, remodeling, installing, replacing, or repairing a house or building, owners refer to professionals through yellow pages or service matching websites. After that, the conventional method is that several professionals visit the site to make an estimate, the owner signs a contract with one of the professionals to proceed with the project, and the parties directly perform the payment process.

In the conventional method, there are not many professionals to be found, most of them have to visit the site to estimate prices, and excessive additional costs, unsatisfactory project results, and non-payment cause frequent disputes. After all, hiring a reliable professional is not easy, and there are many complaints about the price.

As a prior art, there are service matching websites that connect owners and professionals. By their policy, these services select a few of the professionals searched, and only selected professionals can receive with information about potential customers, owners. These services do not support project progress, inspection and payment process.

As a result, the owner is only introduced to a few professionals, and the follow-up procedure for the project must be carried out by the owner himself. Professionals are responsible for the subscription fee of the service matching website, the lead fee for receiving owner information, the cost of listing on the yellow pages, and the cost of visiting the site to make an estimate. Nevertheless, professionals are not guaranteed to win the project.

### SUMMARY

The present invention provides a system and method for supporting a series of processes of searching and selection professionals, contract, project progress, inspection, and payment process.

The following is a preferred embodiment of the present invention. When carrying out projects such as a new construction and addition, remodeling, installation, replacement, and repair of a house or building, it is presented a system and method of intermediary between owners of houses or buildings (hereinafter referred to as “homeowner”) and professionals to ensure that a series of processes leading to ‘Complete the Project’ can proceed smoothly. The platform server provides the homeowner with a specification form prepared for each project type, and the specifications completed by the homeowner is uploaded on the platform server and becomes the object of transaction. These processes are done through a mobile phone. The platform server transmits the uploaded specifications in real time by mobile phone to all professionals whose project type and business area are matched or similar among professionals registered as members on the platform server. The professionals transmit the bid price and conditions to the platform server via mobile phone, and the platform server immediately delivers it to the homeowner via mobile phone. The platform server supports the homeowner's selection of professionals and communication between both parties during the project, and provides each party with a form of inspection on the project result in sequence, and supports the payment process.

In the system and method according to the present invention, homeowners and professionals can contact more counterparties, homeowners can find more suitable professionals and order projects at a reasonable price, and professionals acquire more projects without unnecessary cost and effort. It can reduce the possibility of disputes between homeowners and professionals, and provide evidence that can clearly determine the cause of the dispute.

### Advantageous Effects

In a project such as a new construction and addition, remodeling, installation, replacement, and repair of a house or building according to the present invention, professionals can obtain a method to minimize the cost to acquire the project and to get more project schedule.

In addition, with the present invention, homeowner can obtain a method to access more professionals, a method to accurately estimate project budgets, and a method to use financial services for payment process.

### BRIEF DESCRIPTION OF DRAWINGS

FIG. 1 shows a conceptual diagram of the overall structure of the present invention.

FIGS. 2 to 7 show a diagram of a mobile UI used by a homeowner to create a specification according to an embodiment of the present invention.

FIGS. 8 to 12 show a diagram of a mobile UI used by a homeowner to proceed with a bidding according to an embodiment of the present invention.

FIG. 13 shows a diagram of the procedure for generating project specifications for a related system according to the present invention.

FIG. 14 shows a diagram of a sequence of procedures from publication of project specifications to process of payment of the associated system according to the present invention.

FIG. 15 shows a diagram of the project inspection and evaluation procedure of the associated system according to the present invention.

### DETAILED DESCRIPTION

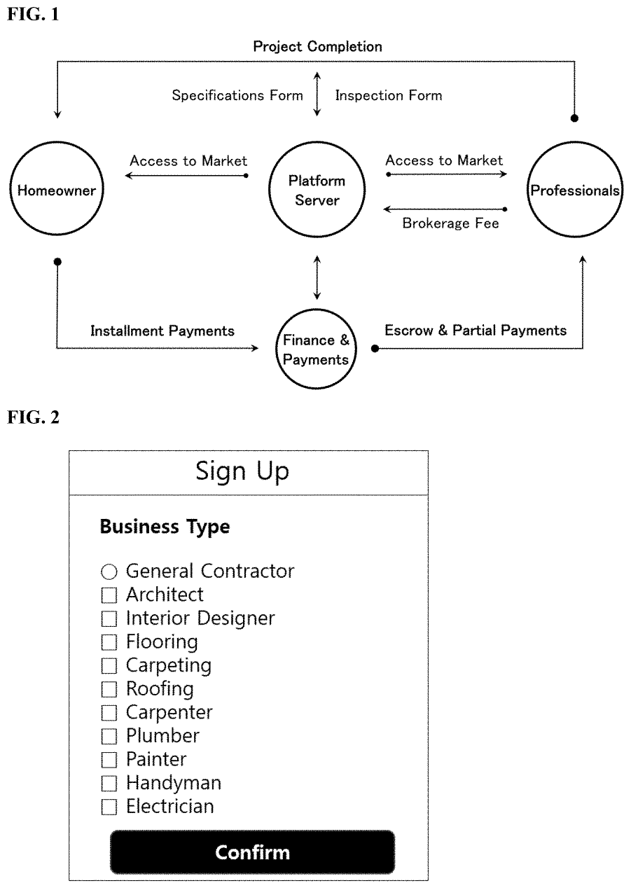

In the related system according to the present invention, in the project such as new construction and addition, remodeling, installation, replacement, and repair of a house or building, as shown in FIG. 1, between the homeowner and the professionals according to the present invention, it supports the entire process of the project from professionals finding to payment, and homeowners and professionals can participate through the mobile app.

Hereinafter, each procedure will be described in detail.

### [Sign Up Professionals]

When the professionals download the app to a mobile phone, the professional's mobile phone number is automatically generated and displayed, and is registered on the platform server. At this time, the professionals may register by modifying the displayed mobile phone number.

After the professional's mobile phone number is registered, the ZIP code of the location where the professional's mobile phone is located is automatically generated and displayed, and is registered on the platform server. At this time, the professionals may register by modifying the displayed ZIP code.

As another embodiment, the professional's mobile phone additionally provides a UI to register the business type of the professionals, such as general contractor, architect, interior designer, flooring, plumber, painter, handyman, and the like.

The business type selected by the professionals is registered on the server through the mobile phone, and after that, if the ZIP code, the professional's business type and the homeowner's project type match or are similar, the homeowner's bid application information is transmitted corresponding professionals.

### [Creation and Upload of Specifications]

It is the most essential part of the present invention.

The platform server provides the homeowner's mobile phone with a specifications UI for the project type selected by the homeowner, and the homeowner can complete the specifications with check marks and simple inputs.

In this process, the homeowner can create the project as the object of the transaction, and inform professionals of the type and scope of the project objectively and in detail.

By notifying the specifications to the professionals, the professionals can make a quote based on the specifications without having to visit the project site. Therefore, the professionals can reduce time and cost to estimate the price, and this cost reduction leads to the lower project price, which is beneficial to the homeowner. Homeowner can also save time by not having to wait for the professional's visit, and more professionals can participate in bidding, allowing more accurate price estimation.

In addition, the present invention is configured to proceed with inspection and payment process based on the specifications.

In other words, the specifications completed by the homeowner serve as an objective criterion for not only the start of the project (price estimation), but also the completion of the project (inspection). In addition, specifications can reduce the factors of dispute between homeowner and professionals, and can serve as objective evidence to determine the responsible party and/or the ratio of responsibility when a dispute occurs.

The platform server provides a specification form for each project type, and the items of the specifications are organized around cost factors. Homeowner can complete the specifications with just a few check markings (for example, within 5 or 10 times) on specifications UI displayed on their mobile phone.

For example, in the mobile phone UI shown in FIG. 2, the homeowner can select a project type (new construction & addition, remodeling, carpeting, painting, plumbing, etc.).

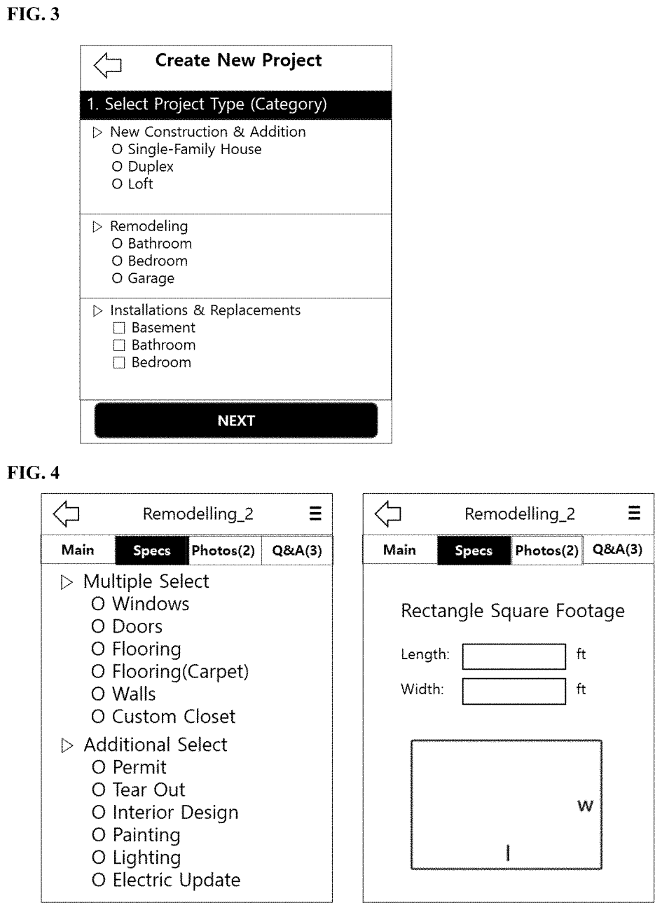

If remodeling (bed room) is selected, a detailed procedure for completing the specifications by the homeowner will be described with reference to FIGS. 3 to 7.

When remodeling (bed room) is selected among the project types in FIG. 3, the specifications UI corresponding to the project appears as shown in FIG. 4. Select the items from the presented UI and enter the area information in the square footage calculator.

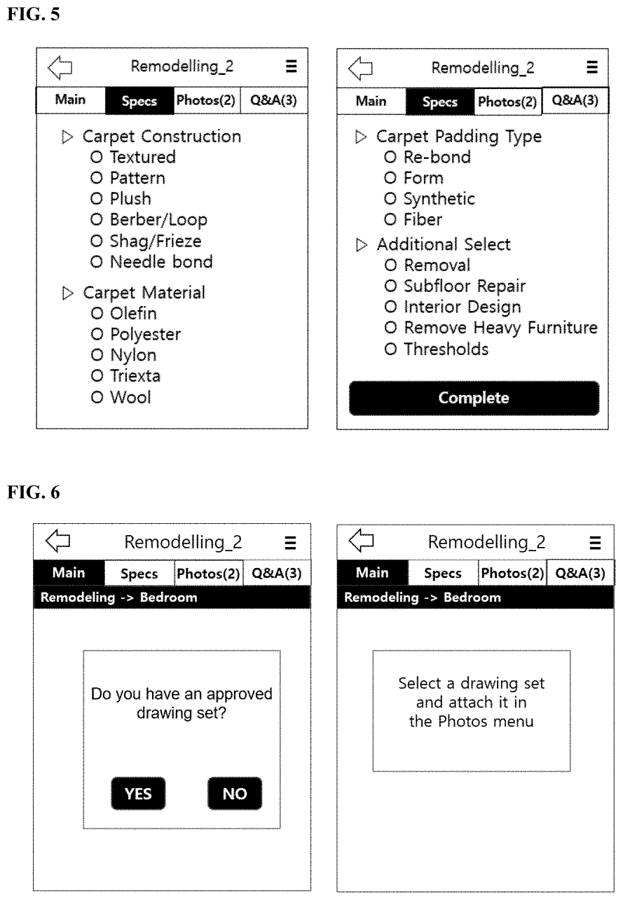

Subsequently, in FIG. 5, specific items for the item selected in FIG. 4 are displayed. In this UI, the homeowner can select detailed items.

For example, the carpet type and/or material may be included in the specifications. In this case, the app installed on the homeowner's mobile phone displays a UI to select and mark a check as shown in FIG. 5, so that the homeowner can easily select the carpet type and/or material.

Of course, the homeowner can directly input the carpet type and/or material he wants.

The homeowner can attach drawings, photos, and videos related to the project through the main menu screen of the mobile phone UI shown in FIG. 6.

With a few clicks above, the homeowner can complete the specifications he wants and is ready to receive the professional's bid.

### [Bidding]

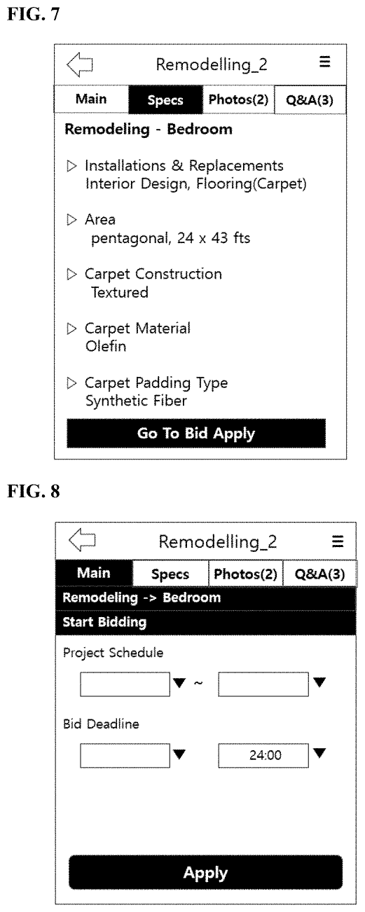

As shown in FIG. 7, the homeowner reviews the contents of the completed specifications, designates the project period (start date, end date) and the bid end date and time in the UI shown in FIG. 8, and applies for a bid.

The platform server first searches for professionals whose ZIP code matches up to a certain range based on the homeowner's registration. It also searches for professionals who have registered business types in the same classification as the project type selected by the homeowner. Found professionals can check the bid application information applied by the homeowner through their mobile phones at any time, and tender after completing the entry of the quotation and payment and warranty terms.

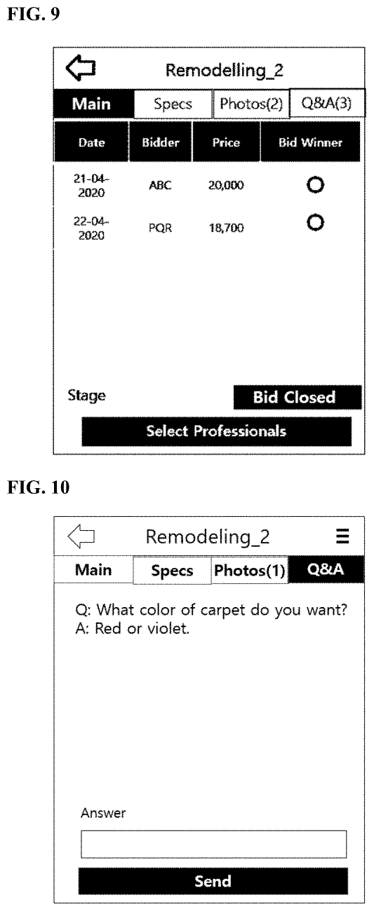

During the bidding available period, as shown in FIG. 9, the homeowner can also check the bidding participants and the bid price at any time with their mobile phone, and select professionals to proceed with the project from among one or more bidding participants (professionals).

The bidding method according to the present invention allows homeowner and professionals to access more counterparties. In particular, professionals who do not have a work schedule during the project period suggested in the specifications may offer a lower bid price.

This feature differentiates it from the conventional matching service, which leads only a limited number of professionals to homeowner.

In addition, when the bidding application information is disclosed, the platform server opens a bulletin board as shown in FIG. 10 to post the professional's questions and homeowner's answers related to the specifications. All professionals can refer to it and provide a more accurate estimate.

### [Contract]

After going through the above-described process, the selected professionals and the homeowner conclude a contract.

Contracts can be conducted offline by meeting homeowner-professionals, but platform servers can support homeowner-professionals to sign contracts online by creating a standard contract that includes specifications and bid terms and conditions.

Alternatively, after the time when the homeowner selects at least one professionals from among the professionals participating in the bidding according to the homeowner's specifications, the platform server automatically considers the agreement between the homeowner and the professionals with the specifications contents and bid price, and it can be configured to notify of the conclusion of contract.

Paper contracts or online contracts are stored on the platform server and used for inspection or used as evidence in case of dispute. That is, the platform server according to the present invention provides a substantial notarization effect.

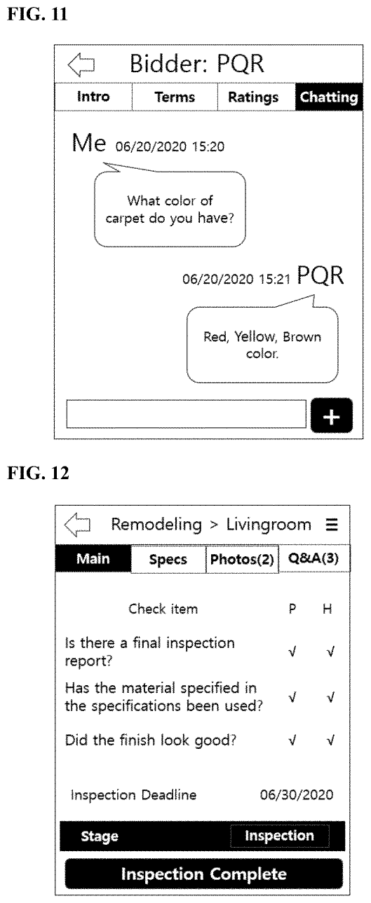

When the contract is concluded, the platform server creates and provides a one-on-one chat window between the homeowner and the professionals as shown in FIG. 11, so that changes, additions, and reports related to the project progress can be conveniently made.

In addition, the contents of the conversation between the homeowner-professionals are stored and can be used as evidence in case of inspection and/or dispute.

### [Payment]

The platform server according to the present invention supports payment processing. In particular, it has scalability in consideration of linkage with loans. It is also configured to escrow a certain amount.

In the payment processing led by the platform server according to the present invention, the homeowner delivers the amount specified in the contract to the platform at each stage of the project, and the platform pays it to the professionals. This method can prevent disputes due to payment between the homeowner and the professionals.

### [Inspection]

Inspection is conducted based on the specifications completed by the homeowner and submitted by professionals. The platform server transmits the inspection form to the professionals, and the professionals marks a result in the inspection form UI. The platform server transmits the inspection form UI that displays the professional's inspection results to the homeowner, and the homeowner completes the inspection within a certain period of time.

In other words, the professional first inspects the project and requests the homeowner's final inspection. The platform server compares the inspection results of the professionals and the homeowner to determine the completion of the inspection, and when the inspection is complete, escrow is automatically released.

As shown in FIG. 12, the inspection deadline is indicated on the inspection form of the homeowner, and if the homeowner's inspection is not completed by the specified deadline, it is automatically regarded as completed.

Unlike this, it goes without saying that the homeowner can designate a third professional supervisor to conduct inspection.

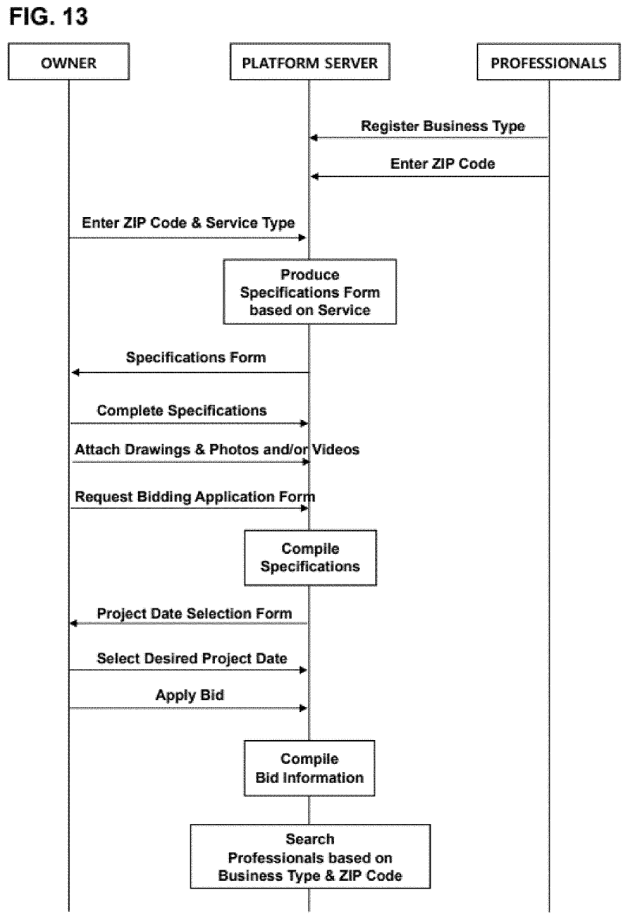

FIGS. 13 to 15 are diagrams showing a project progress procedure between the homeowner and the platform server and between the platform server and the professionals according to the present invention.

As shown in FIG. 13, the professional selects and registers one or more of the business types presented by the platform server, and registers the location using the ZIP code.

The homeowner completes the specification form presented by the platform server by marking and/or inputting on his mobile phone, and selectively transmits drawings, photos, and videos of the project site to the platform server. In addition, the homeowner designates a desired date for the project to proceed and the bid deadline in the calendar presented by the platform server, and applies for a bid.

The platform server transmits bidding information to all professionals whose project type and ZIP code are identical or similar among registered professionals, and opens a bulletin board so that professionals and homeowner can post questions and answers related to bidding information.

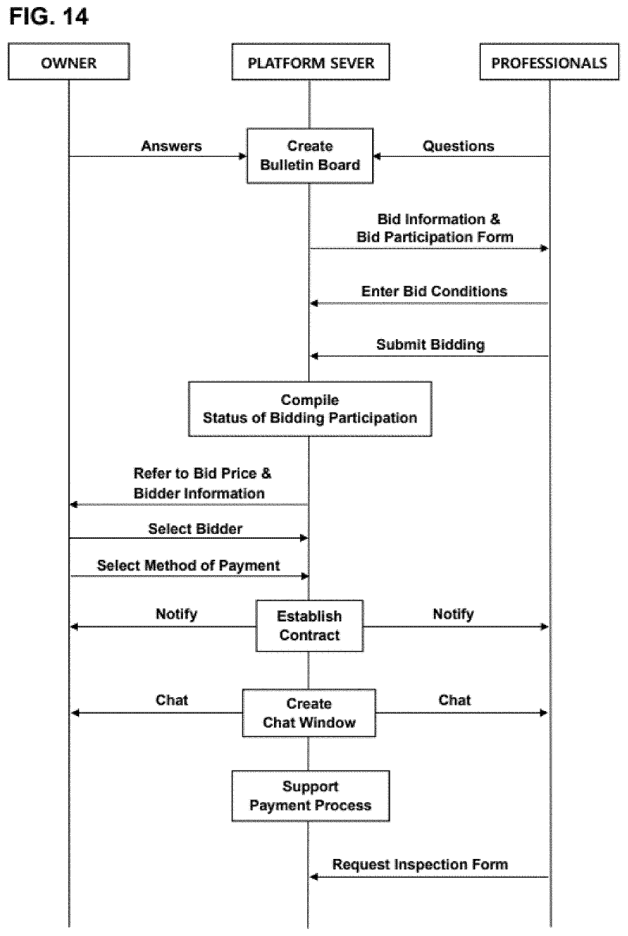

As shown in FIG. 14, the professional enters the bid price and terms in the participation form provided by the platform server using his mobile phone and participates in the bid.

The homeowner refers the information and bid prices of the bidders provided by the platform server, selects the professionals to perform the project, and approves the payment terms presented by the platform server. The platform server notifies professionals and homeowner that a contract has been established, and opens and provides a dialogue window for professionals and homeowner to communicate with each other through mobile phone.

And it supports the payment process.

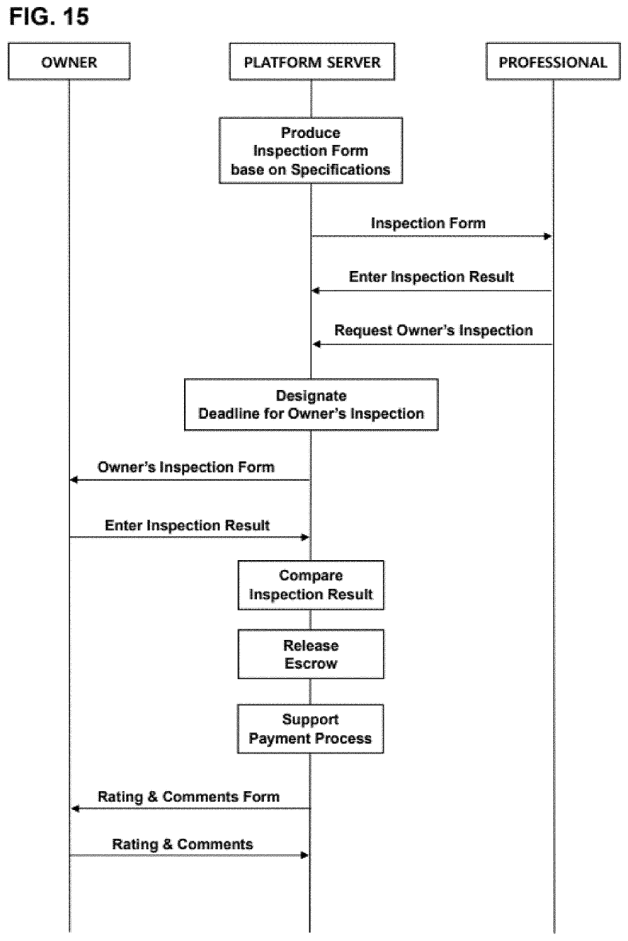

After the project is completed, as shown in FIG. 15, the platform server transmits the inspection form to the professionals for inspection.

The professional marks the check box of the inspection form and transmits it to the platform server, and the platform server transmits the inspection form displaying the professional's inspection result to the homeowner.

The inspection deadline is indicated on the inspection form of the homeowner, and the platform server compares the inspection results of the professionals and the homeowner to determine the completion of the inspection, and supports the payment process.

1. A method performed by a platform server to support a project including at least one of construction, remodeling, installation, replacement, and repair of houses or buildings, comprising:
registering the professionals by receiving registration information from one or more professionals' mobile phone;
providing a specification form to the mobile phone of the owner of the above-mentioned house or building requesting the progress of the project;
receiving a specification form written by the owner from the owner's mobile phone;
receiving a bid application including bid information from the owner's mobile phone, and transmitting the above-mentioned bid information to one or more registered professionals' mobile phone;
receiving bid participation application from one or more professionals' mobile phone, and transmitting the bid participation information to the owner's mobile phone;
notifying the conclusion of a contract between the owner and the professionals selected by the owner;
inspecting after project is completed; and
supporting payment process based on the inspection results.

2. The method of claim 1, wherein registering the professionals comprising:
receiving one or more information selected from the business types presented by the platform server and a ZIP code from the professionals' mobile phone.

3. The method of claim 1, wherein receiving the specifications receives information selected on the mobile phone by the owner according to the specification form.

4. The method of claim 3, wherein receiving the specifications, further comprising:
the step of receiving at least one of drawing, photo, and video of the site of the project to be performed.

5. The method of claim 1, wherein the transmitting of the bidding information comprising:
transmitting bidding information to all registered professionals who have the same project type and similar business areas.

6. The method of claim 1, further comprising opening a bulletin board after transmitting the bidding information to enable the professionals and the owner to post questions and answers related to bidding information.

7. The method of claim 1, wherein the step of performing the inspection process comprising:
transmitting an inspection form to the professionals;
receiving an inspection form in which the professional's inspection result is displayed from the professional's mobile phone;
transmitting an inspection form in which the professional's inspection result is displayed to the owner's mobile phone; and
receiving inspection results from the owner's mobile phone.

8. The method of claim 1, further comprising, after the step of notifying the contract conclusion, opening a chat window through which the professionals and the owner can communicate with each other by mobile phone.
